(19) United States
(12) Patent Application Publication
(10) Pub. No.: US 2017/0193197 A1
(43) Pub. Date: Jul. 6, 2017

(54) SYSTEM AND METHOD FOR AUTOMATIC UNSTRUCTURED DATA ANALYSIS FROM MEDICAL RECORDS

(71) Applicant: Dhristi Inc., Saratoga, CA (US)

(72) Inventors: RAMANDEEP RANDHAWA, HERMOSA BEACH, CA (US); PARAG JAIN, PALO ALTO, CA (US)

(73) Assignee: Dhristi Inc., Saratoga, CA (US)

(21) Appl. No.: 15/396,194

(22) Filed: Dec. 30, 2016

Related U.S. Application Data
(60) Provisional application No. 62/273,092, filed on Dec. 30, 2015.

(51) Int. Cl. G06F 19/00; G06F 17/30

(52) U.S. Cl. CPC G06F 19/363; G06F 19/322; G06F 17/30619; G06F 17/30705

(57) ABSTRACT

According to various embodiments, a method for automatic unstructured data analysis of medical data is provided. The method comprises receiving an unstructured data set corresponding to medical data. The unstructured data set includes data items from a first source and a second source. The method includes extracting, from the unstructured data set, a plurality of keywords and key phrases corresponding to a clinical profile. Next, a vector is generated from the first source and the second source. The vector includes vector elements and corresponds to the clinical profile. Next, the vector elements is normalized for comparison with predetermined clinical trial criteria. Last, vectors that meet the predetermined clinical trial criteria are automatically identified.

### CROSS REFERENCE TO RELATED APPLICATIONS

This application claims priority under 35 U.S.C. §119(e) to U.S. Provisional Application No. 62/273,092, filed Dec. 30, 2015, entitled “SYSTEM AND METHOD FOR IDENTIFYING PEOPLE WITH SIMILAR PROFESSIONAL INTERESTS WITHIN AN ENTERPRISE,” the contents of which are hereby incorporated by reference. This application is related to application Ser. No. 15/379,417, filed Dec. 14, 2016, entitled “SYSTEM AND METHOD FOR TARGETED DATA EXTRACTION USING UNSTRUCTURED WORK DATA,” the contents of which are hereby incorporated by reference.

### TECHNICAL FIELD

The present disclosure relates generally to computer systems, and more specifically to unstructured data systems.

### BACKGROUND

Systems have attempted to use various techniques for identifying suitable candidates that meet clinical trial criteria—typically doctors and clinicians have to review patient's medical history, including unstructured data in doctor's notes and patient medical records. However, this process is manual and tedious, and often results in not finding suitable candidates in time for the trials. Thus, there is a need for an improved method to automatically analyze unstructured data, including medical records, e.g., doctor's notes and other free-text data that cannot be searched or analyzed easily by standard computer systems.

### SUMMARY

The following presents a simplified summary of the disclosure in order to provide a basic understanding of certain embodiments of the present disclosure. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

In general, certain embodiments of the present disclosure provide techniques or mechanisms for automatic unstructured data analysis of medical data. According to various embodiments, a method for automatic unstructured data analysis of medical data is provided. The method comprises receiving an unstructured data set corresponding to medical data. The unstructured data set includes data items from a first source and a second source. The method includes extracting, from the unstructured data set, a plurality of keywords and key phrases corresponding to a clinical profile. Next, a vector is generated from the first source and the second source. The vector includes vector elements and corresponds to the clinical profile. Next, the vector elements are normalized for comparison with predetermined clinical trial criteria. Last, vectors that meet the predetermined clinical trial criteria are automatically identified.

In another embodiment, a system for automatic unstructured data analysis of medical data is provided. The system includes one or more programs comprising instructions for receiving an unstructured data set corresponding to medical data. The unstructured data set includes data items from a first source and a second source. The instructions also include extracting, from the unstructured data set, a plurality of keywords and key phrases corresponding to a clinical profile. Next, a vector is generated from the first source and the second source. The vector includes vector elements and corresponds to the clinical profile. Next, the vector elements are normalized for comparison with predetermined clinical trial criteria. Last, vectors that meet the predetermined clinical trial criteria are automatically identified.

In yet another embodiment, a non-transitory computer readable storage medium is provided. The computer readable storage medium stores one or more programs comprising instructions for receiving an unstructured data set corresponding to medical data. The unstructured data set includes data items from a first source and a second source. The instructions also include extracting, from the unstructured data set, a plurality of keywords and key phrases corresponding to a clinical profile. Next, a vector is generated from the first source and the second source. The vector includes vector elements and corresponds to the clinical profile. Next, the vector elements are normalized for comparison with predetermined clinical trial criteria. Last, vectors that meet the predetermined clinical trial criteria are automatically identified.

### BRIEF DESCRIPTION OF THE DRAWINGS

The disclosure may best be understood by reference to the following description taken in conjunction with the accompanying drawings, which illustrate particular embodiments of the present disclosure.

FIG. 1 illustrates a particular example of a computer system, in accordance with one or more embodiments.

FIG. 2 illustrates an example of a cluster tree, in accordance with one or more embodiments.

FIG. 3 illustrates a flow chart of an example algorithm, in accordance with one or more embodiments.

FIG. 4 illustrates a flow chart of an example method for automatic unstructured data analysis of medical data, in accordance with one or more embodiments.

FIG. 5 illustrates one example of a system that can be used in conjunction with the techniques and mechanisms of the present disclosure in accordance with one or more embodiments.

### DETAILED DESCRIPTION OF PARTICULAR EMBODIMENTS

Reference will now be made in detail to some specific examples of the present disclosure including the best modes contemplated by the inventors for carrying out the present disclosure. Examples of these specific embodiments are illustrated in the accompanying drawings. While the present disclosure is described in conjunction with these specific embodiments, it will be understood that it is not intended to limit the present disclosure to the described embodiments. On the contrary, it is intended to cover alternatives, modifications, and equivalents as may be included within the spirit and scope of the present disclosure as defined by the appended claims.

For example, the techniques of the present disclosure will be described in the context of particular algorithms. However, it should be noted that the techniques of the present disclosure apply to various other algorithms. In the following description, numerous specific details are set forth in order to provide a thorough understanding of the present disclosure. Particular example embodiments of the present disclosure may be implemented without some or all of these specific details. In other instances, well known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

### Overview

According to various embodiments, techniques and mechanisms are provided to develop a patient's profile based on their medical records. The system analyzes free-form text data such as doctor's notes, patient medical records etc. and extracts keywords and key phrases that best describe their medical profile. It also learns a distributed vector representation of the individual, such that patients with similar medical history will be close to each other in vector space. It then compares patients based on their vectors, keywords and key phrases, and matches them to the clinical trial criteria.

### Example Embodiments

In some embodiments, the person's medical profile can be inferred based on data (unstructured and structured). Such inferences can be made by analyzing specific data items, such as electronic medical records. In some embodiments, doctor's notes and other free-form text are also analyzed.

In various embodiments, systems examine one medical record, put the record in a category, and extract the keywords from that record. In such embodiments, keywords are extracted via examining multiple medical records, and look at the “overall” medical profile of a patient. As used herein, “words” or “keywords” will be used interchangeably with “data items” or “data elements” even though “words” only represent one example of “data items,” which can include other types of data, or even metadata, found in medical data, including medical records, doctor's notes, medical history, hospital charts, prescriptions, insurance information, etc.

In some embodiments, the system can identify the medical profile of an individual in vector space. In such embodiments, the advantage of a vector patient profile is that the system can then match patients to complex clinical criteria in an automatic way. In some embodiments, the system accomplishes this task by pinpointing the keywords that best describe the patient and then extrapolating back to see whether the keywords are important in the context of unstructured text communications such as doctor's notes, emails etc. Example algorithms for accomplishing such tasks are discussed below.

Generalized Overview of Algorithm

In some embodiments, systems use frequency count to show “intensity,” or importance, of a topic. However, the often times, frequency of a word is not sufficient for determining the intensity of a particular topic because often times a patient can use multiple different words, but with similar meaning, to talk about a topic. For example, if a person talks frequently about “bread,” but always uses other forms of the word, e.g. “sourdough,” “ciabatta,” “Dutch crunch,” etc., then frequency of each of the similar words would not demonstrate the actual intensity of the topic “bread.”

Thus, in some embodiments, the system uses a dimensional space approach. In some embodiments, data elements in a data set are “squeezed” into a dimensional space based on certain characteristics of the data set. If data elements are close/similar in meaning, then they appear closer in the dimensional space. In such embodiments, a lot of data is needed because otherwise a sample space is too small and the system will confuse words that are actually opposite in meaning to be “similar.” For example, with a small sample space, the system may confuse “love” and “hate” as similar words because they are generally used in the same context (“I love you” and “I hate you”). However, with a large enough sample space, the system can actually discern such a difference. Thus, determining the intensity of a topic often requires a large enough sample size/space and usually does not work very well on “limited data.” However, emails count as “limited data,” so in order to accurately determine the intensity of topics in emails, different techniques may be employed.

In various embodiments, a method for determining the intensity of a topic (topic modeling) starts with a data set, e.g. a plurality of doctor's notes, emails etc. The text documents are analyzed and parsed. Then the words of the documents are placed into vectors, also known as generating vector representation of the documents. In some embodiments, a second vector representation is generated, but on a different source. The second vector representation is run on a global knowledge base source, e.g. Pubmed. In some embodiments, the reason for having two vector representations with a global source and a personal source (doctor's notes) is to augment the universal/general meaning of a word (from Pubmed or some other encyclopedic/dictionary source) with a patient's own specialized meaning (extrapolated from the context of the doctor's notes).

In various embodiments, once the two vectors have been generated, then the system merges/concatenates them. In some embodiments, both vectors are multi-dimensional vectors, and thus merging two multi-dimensional vectors yields a multi-dimensional vector, with each dimension being another multidimensional vector.

In various embodiments, the system then runs a clustering algorithm on the merged vector. In some embodiments, the clustering algorithm can be any standard clustering algorithm. In some embodiments, the result of the clustering algorithm yields a tree representation of words in the data set. In some embodiments, the tree has roots, and the “deepest” roots (words) are identified. In some embodiments, the “deepness” of a word correlates with how “specific” a word is. For example, “love” is a more general term and encompasses “lust.” Hence, “love” would not be represented as deeply in the tree as “lust.”

In some embodiments, the clusters with the highest density are the clusters with the deepest words. For example, a deepest word for a person could be “processor,” because the person works with computers and is constantly talking about processors or similar computer topics.

In some embodiments, the idea is to count the frequency/density of “similar words,” in order to determine the intensity of a topic. However, in some embodiments, the deepest words do not necessarily translate into real meaning for a patient. This can be due to the fact that some of the deepest words can be very technical words. Thus, in various embodiments, the system also measures a “degree” of a word. A degree measure of a word can mean: for every word, how many unique words are also used with the word. For example, given the two sentences: “I love you,” and “You love hotdogs,” the word love is associated with three unique words. So the degree measure for love, in the limited example above, is three.

In various embodiments, the degree measure can yield a very high number, because there can be many unique words used with a certain word if the data set is large. Similarly, for a deepness measure, the value can also be quite large. Thus, in order to scale down the degree and deepness measures into workable values, the system may normalize both numbers.

In various embodiments, one method for normalizing the deepness measure is to scale to the measure to a percentage. Thus, all values for the deepness measure are given on a scale between 0 and 1, with 1 being a hundred percent.

In various embodiments, one method for normalizing the degree measure is to take the log of the absolute value of the degree measure and then scale the log value by a max log value. That way, for highly skewed data, normalization offers workable values for practical implementation.

In various embodiments, the normalized values are also power transformed in order to bring the medians of both values into close proximity. The reason for this is because the medians for both the degree and deepness will probably be in different parts of the scale. Thus, power transforming is necessary to bring the two medians within proximity of each other in order to have a meaningful comparison. Otherwise, in some embodiments, the degree measures will over power the deepness measure. For example a non-power transformed normalized degree median may equal 0.7, and a non-power transformed normalized deepness median may be 0.2. Thus, degree may always overpower the deepness measure in the example represented above. Thus, the system power transforms both normalized medians in order to bring both values to 0.5. One method of doing this is to either take the square or take the square root of the value.

After power transforming the normalized values, the numbers are added to form a score. In some embodiments, every word in the data set is assigned a score. In some embodiments, the scores are used to assign a rank to the words. The rank of a word tells the intensity of the word relative to the patient.

In some embodiments, the scored words are ranked and then matched to different topics, for example via clustering. In some embodiments, because a topic is just a set of words that have similar meaning, each cluster may represent a topic. In some embodiments, in order to determine the topic that is most interesting to a patient, the scores in each cluster/topic are then added up and the highest scores for each cluster/topic is labeled the topic of most interest. Now that a generalized overview of an example algorithm has been explained, a specific example implementation of an algorithm is presented, in accordance with various embodiments of the present disclosure.

Specific Example Implementations of Algorithm

For the purposes of this specific example, a patient's medical records will be the patient's dataset. The example algorithm involves the following steps:

First, compute a high-dimensional distributed vector representation for each word in a patient's vocabulary. In some embodiments, traditional NLP techniques treat words as atomic units, and represent them as 0/1 indices in the vocabulary—there is no notion of similarity between words. In some embodiments, techniques use a distributed vector representation of words to capture their semantic and syntactic meaning. These vectors are learned from huge datasets with billions of words, and with millions of words in the vocabulary, and are typically in 100-1000 dimension space. These vectors are such that similar words tend to be close to each other in space, and their cosine distance is a good measure of semantic similarity. However, because a patient's dataset is typically much smaller, usually a million words or less, and is not enough to learn a high dimensional vector that captures their full meaning, the algorithm includes learning two different vector representations for each word: a global word vector and a personalized vector. The global vector is learned from public datasets such as Pubmed, that captures the generic meaning. In this particular example, the system uses 300 dimension vectors for the public dataset. The personalized word vector is learned from the patient's dataset, that captures the meaning in their context. In this particular example, the system uses 25 dimension vectors.

The system then concatenates these two vectors to generate a 325 vector representation for each word. Personalized vectors have the desired effect of taking words that frequently co-occur in a patient's context, and are reasonably close in global vector space, and pull them closer to form dense clusters—these groups of words represent a patient's medical profile.

Next, the system generates a topic score for each word—this is a combination of two distinct concepts, depth and degree. For depth: the system performs Agglomerative Clustering on all the patient's words, using the 325 dimensional vector representation for each word. As a note, each unique noun in the patient's vocabulary is represented as a point in 325 dimensional space. Then, the system performs clustering on these words.

In various embodiments, clustering methods work by grouping similar points. Instead of simply outputting groups of words or points, agglomerative clustering creates a tree structure called a dendrogram as follows: first, an empty tree is initialized and then the overall closest two points are picked and added to the tree (the two points are the leaf nodes of the tree) and these are joined together at a root node (which is a dummy node, and has the position of the center of the two points joined). This process repeats and the entire tree is created. At the end of this construction, the tree has one overall root node, at which all branches merge, and all words/points are represented by leafs of the tree. In some embodiments, the depth measure of a word is defined by the length of the path from the overall root node of the tree to the word.

In some embodiments, words that are important to a patient should contain many words that have similar meaning. For instance, for a patient, there would be many words such as “catheter, chest, atrial, ventricular,” that have similar meanings (relative to all English words). So, when doing the Agglomerative Clustering, the branches of the tree with these words will be very long, and this will be reflected in the depth of these words being high. As a note, some higher level words such as “heart disease” or “cardio” may not have high depth. Thus a degree measure is also included.

For degree: the notion of degree is used in graph theory (a graph depicts relationships between entities represented as nodes using edges that connect the nodes). For example, social networks use graph theory extensively to represent relationship between people; the Google PageRank algorithm applied graph theory to web-pages to identify the most important web-page based on search queries.

In various embodiments, the system builds a graph using the patient's data. In particular, the algorithm defines as nodes: all words in the patient's vocabulary, and then for each sentence in the patient's data, the algorithm considers all words used in the sentence to be connected via edges. The degree of a word in this graph is defined as the number of neighbors the word has. Equivalently, the degree of a node/word is the number of edges that leave the node/word.

In some embodiments, words have high degree if they have many neighbors, i.e., they are used along with many different words. This can be interpreted as the words being used in many different contexts. Thus, words with high degree can be construed as topical words.

For combining degree and depth: In some embodiments, degree and depth capture different aspects of importance. For a word, high depth implies that it belongs close to important words, and high degree implies that this is a topical word. So, by combining these two measures, the system captures the important topics of the patient. In some embodiments, degree and depth are very different measures. As an example, the highest depth tends to be between 30 and 70, whereas the highest degree is typically in several thousands. Further, the spread of these two scores across different words is also very different. Most words have very low degree, in the single digits, and a handful of words can have a degree of several thousand. Thus, to combine the two measures, the system normalizes them.

Normalization Formulae: First, the system normalizes depth by dividing by the largest value. Next, the system takes a Logarithmic Transformation of degree, by taking the natural logarithm of degree+1 for each word (adding 1 is standard and is done to deal with zero degree words, so their natural logarithm is well defined). Then, the log is divided by natural logarithm of max_degree+1.

Next, a power transformation is performed on both depth and degree to ensure their medians are the same. Thus, in some embodiments, the [Score=f(depth,degree)].

Last, in order to identify important topics, the system performs K-means clustering with K=10. This means that the system takes all words in the patient's vocabulary and clusters them into K=10 groups. Because the grouping is by similarity, this gives 10 topics of potential interest to the patient. The topic score is then calculated for each of the ten topics by summing the score of each of the words that belong to that topic. The topic with the highest score is ranked as the one that is most important to the patient, and the one with the second highest score as the one that is second in importance, and so on. Thus, a specific example algorithm is provided. Next, a detailed description of the figures is provided.

### Detailed Description of the Figures

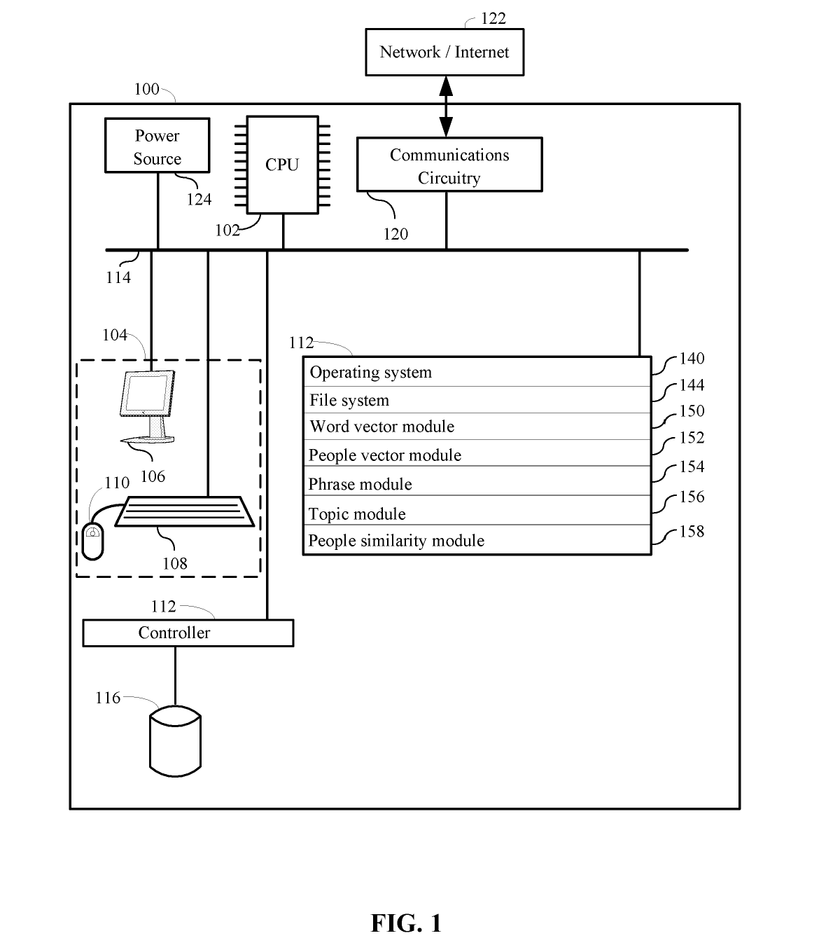

FIG. 1 is a block diagram illustrating an example of a computer system capable of implementing various processes described in the present disclosure. The system 100 typically includes a power source 124; one or more processing units (CPU's) 102 for executing modules, programs and/or instructions stored in memory 112 and thereby performing processing operations; one or more network or other communications circuitry or interfaces 120 for communicating with a network 122; controller 112; and one or more communication buses 114 for interconnecting these components. In some embodiments, network 122 can be the another communication bus, the Internet, an Ethernet, an Intranet, other wide area networks, local area networks, and metropolitan area networks. Communication buses 114 optionally include circuitry (sometimes called a chipset) that interconnects and controls communications between system components. System 100 optionally includes a patient interface 104 comprising a display device 106, a keyboard 108, and a mouse 110. Memory 112 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 112 may optionally include one or more storage devices 116 remotely located from the CPU(s) 102. Memory 112, or alternately the non-volatile memory device(s) within memory 112, comprises a non-transitory computer readable storage medium. In some embodiments, memory 112, or the computer readable storage medium of memory 112 stores the following programs, modules and data structures, or a subset thereof:
an operating system 140 that includes procedures for handling various basic system services and for performing hardware dependent tasks;
a file system 144 for storing various program files;
a word vector module 150 that takes as input a corpus of structured or unstructured data and returns as output a high-dimensional vector for each word in the input corpus;
a patient vector module 152 that takes as input a corpus of unstructured data about an individual, and word vectors for all words in the corpus, and outputs a high-dimensional vector for the individual;
a phrase module 154 that takes as input an unstructured corpus of words and their vector representations, and generates vector representations for phrases of consecutive and/or non-consecutive words;
a topic module 156 that takes as input a set of words along with their high-dimensional vector representations (from module 150) and a set of phrases along with their high-dimensional vector representations (from module 154). The module outputs different sets of words and phrases, each such set represents a clinical profile for the Patient. Further, the topics are ranked in terms of importance to patient, and within each topic, the words and phrases are ranked based on importance;
a patient similarity module 158 that takes as input the patient vectors (from module 152), and their topic words and phrases (from module 156) and computes a similar score. This score is computed for all patients, and is used to identify patients that meet clinical trial criteria.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 112 may store a subset of the modules and data structures identified above. Furthermore, memory 112 may store additional modules and data structures not described above.

Although FIG. 1 shows a “system for automatic unstructured data analysis of medical data,” FIG. 1 is intended more as functional description of the various features which may be present in a set of servers than as a structural schematic of the embodiments described herein. In practice, and as recognized by those of ordinary skill in the art, items shown separately could be combined and some items could be separated. For example, some items shown separately in FIG. 1 could be implemented on single servers and single items could be implemented by one or more servers. The actual number of servers used to implement a topic modeling system and how features are allocated among them will vary from one implementation to another, and may depend in part on the amount of data traffic that the system must handle during peak usage periods as well as during average usage periods.

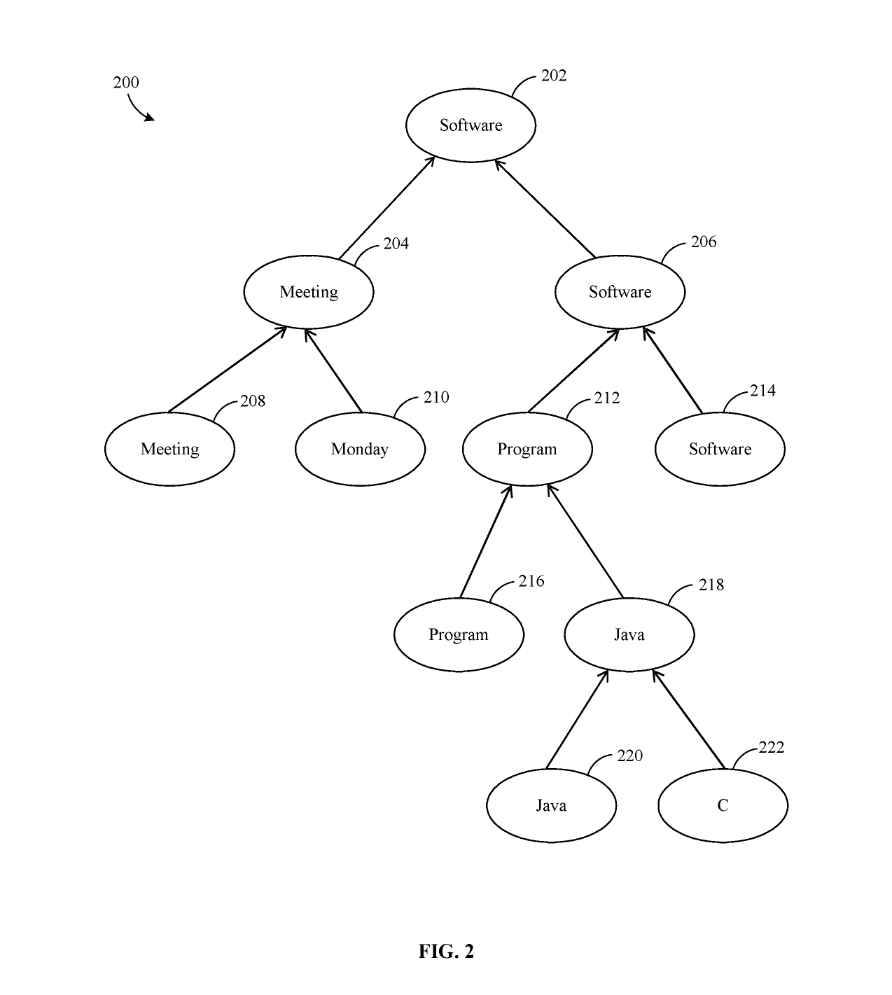

FIG. 2 illustrates an example of a cluster tree, in accordance with one or more embodiments. FIG. 2 depicts the output of the clustering module 200. This output is in the form of a tree, in which the “terminal” or “leaf” nodes are: 208, 210, 214, 216, 220, and 222.

When given an input set of words, the clustering module works in the following steps:

It starts by putting every word into its own cluster—it then locates the words that are closest to each other in high-dimensional vector space and merges them into a cluster. The measure of this distance can be defined appropriately. In this example, the two closest words are 220 (Java) and 222(C). These nodes are merged into a higher level node: 218, and a label is given to the node.

This process is iteratively repeated until all nodes are merged: 208 and 210 merge into 204, 216 and 218 merge into 212, 212 and 214 merge into 206 and finally, 204 and 206 merge into 202. The top-most node, 202, is the root node of the tree.

The labels for each of the non-leaf nodes (202, 204, 206, 212, 218) are computed by the following two steps:

First, a vector is computed for each node—it is the weighted average of word vectors of all leaf nodes found in the subtree below the node. For example, the vector for node 204 is the weighted average of the vectors of 208 and 210. The vector for 212 is the weighted average of 216, 220 and 222.

Second, a label is given for each node. The label for each node is the leaf node (among those that are in the subtree below this node) which is closest to the node. Ties can be broken in any chosen manner. So, for node 212, the vector of 216 is closest to the vector of 212, and hence the label for 212 is program, which is the label for node 216.

The depth of a word is defined as the length of the path from the leaf nodes to the root of the tree. For example, nodes 220 and 222 have the highest depth, as they take 4 hops to get from the leaf to the root of the tree.

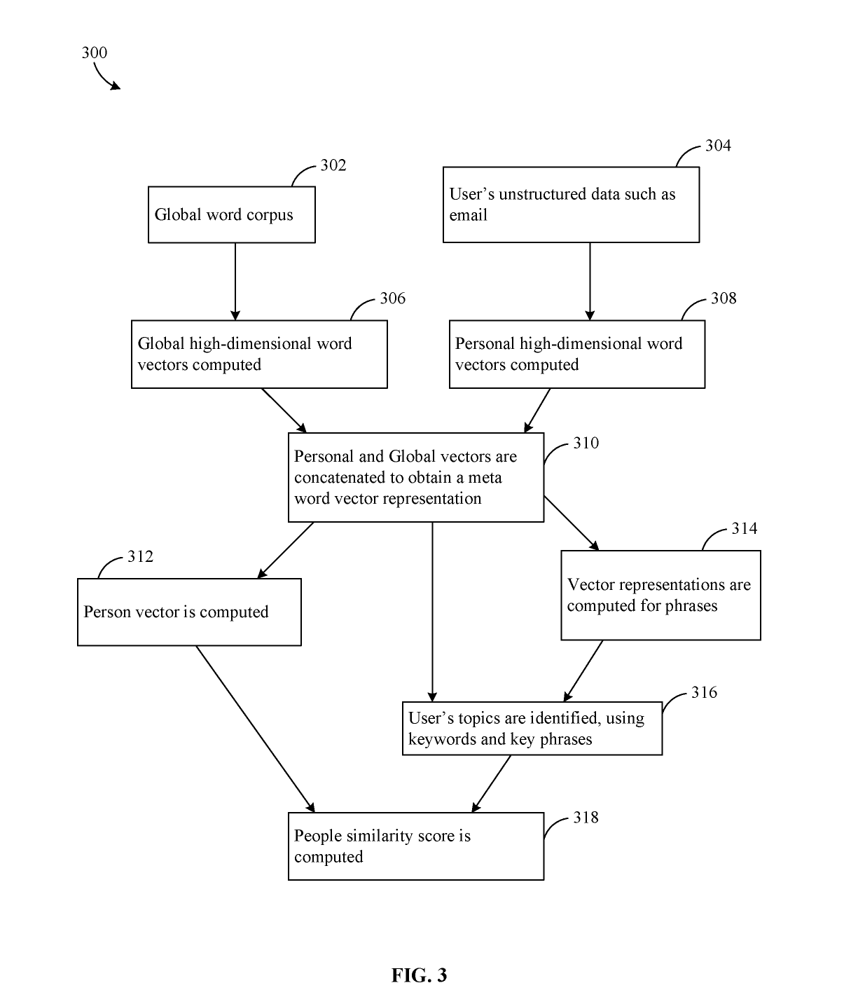

FIG. 3 illustrates a flow chart of an example algorithm, in accordance with one or more embodiments. The algorithm 300 involves the following steps:

At 302, the system takes a global word corpus with billions of words, and millions of unique words in the vocabulary. This corpus includes public datasets such as Pubmed and others.

At 306, the system uses the word vector module (150) from FIG. 1 to learn a high-dimensional distributed vector representation for each global word. The global vectors capture the generic meaning of words, such that similar words tend to be close to each other in vector space, and their cosine distance is a good measure of semantic similarity.

At 304, the system takes a personal word corpus—this captures patient data such as doctor's notes. This corpus is usually smaller, of the order of millions of words, with 10s of thousands of words in the vocabulary.

At 308, the system uses the word vector module (150) from FIG. 1 to learn a high-dimensional distributed vector representation for each word in the personal corpus. These personal vectors tend to capture the meaning in a patient's context, and tend to be smaller in dimension than their global counterparts.

At 310, the global and personal vectors for a given word are concatenated to obtain a meta-word vector representation. This step has the desired effect of taking words that frequently co-occur in a patient's context, and are reasonably close in global vector space, and pull them closer to form dense clusters—these groups of words represent a patient's keywords.

At 312, the system uses the patient vector module (152) to learn a high-dimensional distributed vector representation for each person. This module takes the meta-word vector representation and the patient's unstructured data, and learns how to use their data to predict the individual. In this process, it learns a vector representation for the individual, such that patients that have similar clinical profile tend to be close to each other in vector space.

At 314, the system uses the phrase vector module (154) to learn vector representations for varying length phrases that includes consecutive/ non-consecutive noun phrases. The reason is that, in some of embodiments, topics are best described as noun phrases—these nouns generally show up at varying distances within a context window. This module learns the vector representations of these phrases, and acts as input to the topic module.

At 316, the system uses the topic module (156) to determine the topics by importance to the patient. The topic module (156) is also used to define, for each topic, the keywords and key phrases that best describe it.

At 318, the system uses the patient similarity module (158) to compute a score for people similarity using a combination of their patient vector, as well as their topic keywords and key phrases. The reasoning is that, in some embodiments, people who show up in similar contexts, and have similar profile will have high similarity score. This score is computed for all patients, and is used to match patients to target clinical profile.

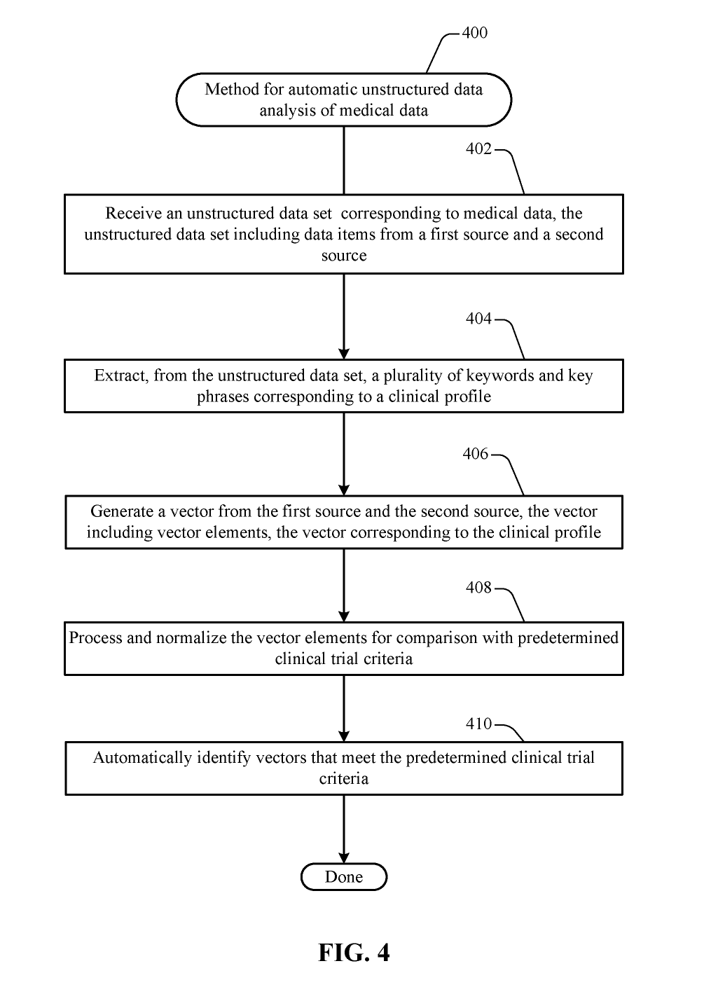

FIG. 4 illustrates a flow chart of an example method 400 for automatic unstructured data analysis of medical data, in accordance with one or more embodiments. Method 400 begins with receiving 402 an unstructured data set corresponding to medical data. In some embodiments, the unstructured data set is a plurality of medical records and doctor's notes for a patient. In some embodiments, the unstructured data set includes data items from a first source and a second source. In some embodiments, the first source is a global source, e.g. Pubmed. In some embodiments, the second source is a personal source, such as the medical records and doctor's notes.

At 404, the method includes extracting, from the unstructured data set, a plurality of keywords and key phrases corresponding to a clinical profile. At 406, the method includes generating a vector from the first source and the second source. In some embodiments, the vector including vector elements and the vector corresponds to the clinical profile. Next, at 408, the method includes processing and normalizing the vector elements for comparison with predetermined clinical trial criteria. Finally, at 410, the method includes automatically identifying vectors that meet the predetermined clinical trial criteria.

In some embodiments, the processing and normalizing of the vector elements may be performed using the methods and systems provided in the related patent “SYSTEM AND METHOD FOR TARGETED DATA EXTRACTION USING UNSTRUCTURED WORK DATA,” which, as described above, is incorporated herein by reference.

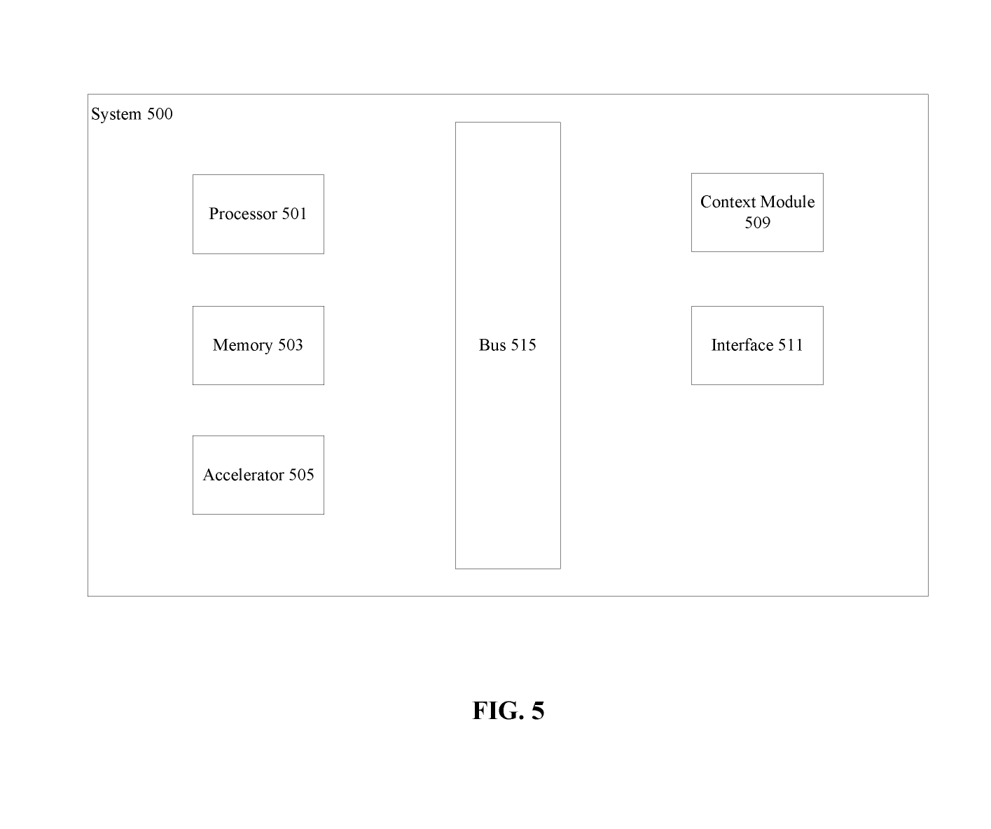

FIG. 5 illustrates one example of a system 500, in accordance with one or more embodiments. According to particular embodiments, a system 500, suitable for implementing particular embodiments of the present disclosure, includes a processor 501, a memory 503, an interface 511, and a bus 515 (e.g., a PCI bus or other interconnection fabric) and operates as a streaming server. In some embodiments, when acting under the control of appropriate software or firmware, the processor 501 is responsible for various processes, including processing inputs through clustering algorithms. Various specially configured devices can also be used in place of a processor 501 or in addition to processor 501. The interface 511 is typically configured to send and receive data packets or data segments over a network.

In some embodiments, system 500 further comprises context module 207 configured for extracting and determining the context for data items as described in more detail above. Such a context module 207 may be used in conjunction with accelerator 505. In various embodiments, accelerator 505 is an additional processing accelerator chip. The core of accelerator 305 architecture may be a hybrid design employing fixed-function units where the operations are very well defined and programmable units where flexibility is needed. In some embodiments, context module 507 may also include a trained neural network to further identify correlated data items in unstructured data. In some embodiments, such neural networks would take unstructured data and specified data items in the unstructured data as input and output correlation values between the data items.

Particular examples of interfaces supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the system 500 uses memory 503 to store data and program instructions for operations including training a neural network, object detection by a neural network, and distance and velocity estimation. The program instructions may control the operation of an operating system and/or one or more applications, for example. The memory or memories may also be configured to store received metadata and batch requested metadata.

Because such information and program instructions may be employed to implement the systems/methods described herein, the present disclosure relates to tangible, or non-transitory, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

In some embodiments, advantages provided by the system and methods described above include automatically extracting targeted information from unstructured data. As a result, existing computer functions are improved because data does not need to be pre-processed and converted by separate computer programs into structured data with known formats. Thus, computers implementing the methods to topic model using unstructured data perform faster and with less processing power. Additionally, processing unstructured data directly without first transferring/converting data to intermediary structured data further reduces required data storage for the systems described herein.

In addition, by implementing the vectors and clustering with the deepness and degree measure as described, the system extracts target and relevant data more accurately because mistakes based on sole frequency reliance is drastically reduced.

In addition, in some embodiments, the system includes an additional context module that may include a neural network trained to increase accuracy of context correlation for data items by the computer. In some embodiments, the accelerator provides a specialized processing chip that works in conjunction with the context module to compartmentalize the processing pipeline and reduce processing time and delay. Such accelerators are specialized for the system and are not found on generic computers.

While the present disclosure has been particularly shown and described with reference to specific embodiments thereof, it will be understood by those skilled in the art that changes in the form and details of the disclosed embodiments may be made without departing from the spirit or scope of the present disclosure. It is therefore intended that the present disclosure be interpreted to include all variations and equivalents that fall within the true spirit and scope of the present disclosure. Although many of the components and processes are described above in the singular for convenience, it will be appreciated by one of skill in the art that multiple components and repeated processes can also be used to practice the techniques of the present disclosure.

What is claimed is:

1. A method for automatic unstructured data analysis of medical data, the method comprising:
receiving an unstructured data set corresponding to medical data, the unstructured data set including data items from a first source and a second source;
extracting, from the unstructured data set, a plurality of keywords and key phrases corresponding to a clinical profile;
generating a vector from the first source and the second source, the vector including vector elements, the vector corresponding to the clinical profile;
processing and normalizing the vector elements for comparison with predetermined clinical trial criteria; and
automatically identifying vectors that meet the predetermined clinical trial criteria.

2. The method of claim 1, wherein each vector includes the extracted keywords and phrases.

3. The method of claim 1, wherein processing and normalizing the vector elements includes running clustering algorithms on the vector elements.

4. The method of claim 1, wherein the vector is a concatenation of two smaller vectors, the smaller vectors including a first smaller vector corresponding to the first source and a second smaller vector corresponding to the second source.

5. The method of claim 1, wherein identifying vectors includes generating a similarity score for the vector with reference to the predetermined clinical trial criteria.

6. The method of claim 1, wherein the vector is a multi-dimensional vector.

7. The method of claim 1, further comprising generating multiple vectors corresponding to multiple clinical profiles.

8. A system for extracting a patient's clinical profile, the system comprising:
one or more processors;
memory; and
one or more programs stored in the memory, the one or more programs comprising instructions for:
receiving an unstructured data set corresponding to medical data, the unstructured data set including data items from a first source and a second source;
extracting, from the unstructured data set, a plurality of keywords and key phrases corresponding to a clinical profile;
generating a vector from the first source and the second source, the vector including vector elements, the vector corresponding to the clinical profile;
processing and normalizing the vector elements for comparison with predetermined clinical trial criteria; and
automatically identifying vectors that meet the predetermined clinical trial criteria.

9. The system of claim 8, wherein each vector includes the extracted keywords and phrases.

10. The system of claim 8, wherein processing and normalizing the vector elements includes running clustering algorithms on the vector elements.

11. The system of claim 8, wherein the vector is a concatenation of two smaller vectors, the smaller vectors including a first smaller vector corresponding to the first source and a second smaller vector corresponding to the second source.

12. The system of claim 8, wherein identifying vectors includes generating a similarity score for the vector with reference to the predetermined clinical trial criteria.

13. The system of claim 8, wherein the vector is a multi-dimensional vector.

14. The system of claim 8, wherein the one or more programs further comprise instructions for generating multiple vectors corresponding to multiple clinical profiles.

15. A non-transitory computer readable storage medium storing one or more programs configured for execution by a computer, the one or more programs comprising instructions for:
receiving an unstructured data set corresponding to medical data, the unstructured data set including data items from a first source and a second source;
extracting, from the unstructured data set, a plurality of keywords and key phrases corresponding to a clinical profile;
generating a vector from the first source and the second source, the vector including vector elements, the vector corresponding to the clinical profile;
processing and normalizing the vector elements for comparison with predetermined clinical trial criteria; and
automatically identifying vectors that meet the predetermined clinical trial criteria.

16. The non-transitory computer readable medium of claim 15, wherein each vector includes the extracted keywords and phrases.

17. The non-transitory computer readable medium of claim 15, wherein processing and normalizing the vector elements includes running clustering algorithms on the vector elements.

18. The non-transitory computer readable medium of claim 15, wherein the vector is a concatenation of two smaller vectors, the smaller vectors including a first smaller vector corresponding to the first source and a second smaller vector corresponding to the second source.

19. The non-transitory computer readable medium of claim 15, wherein identifying vectors includes generating a similarity score for the vector with reference to the predetermined clinical trial criteria.

20. The non-transitory computer readable medium of claim 15, wherein the vector is a multi-dimensional vector.
